(19) United States
(12) Patent Application Publication
(10) Pub. No.: US 2022/0334694 A1
(43) Pub. Date: Oct. 20, 2022

(54) IMPLEMENTATION METHOD AND DEVICE BASED ON HTTP LOOP REQUEST

(71) Applicant: Chengdu Vantron Technology Co., Ltd., Chengdu (CN)

(72) Inventors: Bo Wei, Chengdu (CN); Shufei Han, Chengdu (CN); Rui Jiang, Chengdu (CN); Chengxian Du, Chengdu (CN); Fangai Liu, Chengdu (CN)

(21) Appl. No.: 17/680,632

(22) Filed: Feb. 25, 2022

(30) Foreign Application Priority Data
Apr. 15, 2021 (CN) 202110403812.0

(51) Int. Cl. G06F 3/0484; H04L 67/75; G06F 3/04817

(52) U.S. Cl. CPC G06F 3/0484; H04L 67/75; G06F 3/04817

(57) ABSTRACT

The present invention relates to the field of control buttons of web front-end UI interface. The present invention discloses an implementation method and device based on Http loop request, comprising a button module, a progress bar module and a loading state module, wherein, the button module is a basic resident module, the progress bar module is a ring structure wrapping the button module, and the loading status module is located in the center of the button module, which can intuitively display the countdown of the loop sending request, wait for the loading status of the request results and send the customize reset request. It is convenient for prompting the user of the current web state and can optimize the user operation experience. Moreover, the three components of progress bar, loading status, and button are unified, saving the web layout space.

### CROSS REFERENCE TO RELATED APPLICATIONS

The present application claims the benefit of Chinese Patent Application No. 202110403812.0 filed on Apr. 15, 2021, the contents of which are incorporated herein by reference in their entirety.

### FIELD OF THE INVENTION

The invention relates to the technical field of control buttons of web front-end UI interface, and more particular to an implementation method and device based on Http loop request.

### BACKGROUND OF THE INVENTION

Most of the existing web front-end UI frameworks have independent button, progress bar, and wait state prompt function which are displayed and applied separately in concrete applications. In most short-time interval loop requests or websocket communication, there is no request countdown prompt, resulting in a waste of web layout space and poor user experience.

### BRIEF SUMMARY OF THE INVENTION

The purpose of the present invention is to provide an implementation method and device based on Http loop request to overcome the defect of the prior arts that prompt functions of button, progress bar and wait state are applied and realized separately in the applications, and most of them have no request countdown prompts in short-time interval loop requests or websocket communication.

In order to achieve the above-mentioned purpose, the present invention provides the technical solution as follows:

an implementation method and device based on Http loop request, comprising the following steps:

Step 1: setting an initial loading state of the button module as false, a countdown progress bar display of the countdown module as false and a remaining time of the countdown as zero;

Step 2: clicking the button module to initiate the Http loop request;

Step 3: setting a loading state of the button module as true, wherein the loading state module displays in loading state and waits for a result returned from the backend;

Step 4: after the result returned from the backend is received, setting the loading state as false, the countdown progress bar display as true, the filling progress as 100%, and resetting the remaining time of the countdown as an initial interval value;

Step 5: as the remaining time of the countdown decreases, the filling progress of the countdown progress bar module decreases, when the remaining time decreases to zero, setting the display of the countdown progress bar module as false, and re-initiating the Http request to go to Step 3.

With the above technical solution, the countdown of the request initiation interval is intuitively displayed, which is convenient for prompting the user of the current web state. The button combines the functions of request initiation and request refresh and optimizes the user's operation experience.

As a preferred solution of the present invention, the loading state of the button module stated in Step 3 is set as true, and when the loading state is displayed, the button module is disabled.

As a preferred solution of the present invention, after the results returned from the backend are received as described in Step 4, the button module at this moment displays the available state, and the initial time interval value can be customized to 1s, 2s or 3s (the initial value can also be automatically defined as other values).

The present invention further provides a device of the implementation method based on Http loop request, comprising:

a button module which is a basic resident module and used to click the button module to initiate the Http loop request;

a progress bar module which is a ring structure wrapping the button module and used to display the countdown time;

a loading state module which is located in the center of the button module and used to display the loading state of the button module.

With the above technical solution, the progress bar module, the loading state module and the button module are unified to save web layout space and intuitively display the countdown of the request initiation interval, so as to prompt the user of the current web state and optimize the user operation experience.

As a preferred embodiment of the present invention, the button module is circular, and the internal icons can be customized.

As a preferred embodiment of the present invention, the progress bar module is hidden under normal state, and displayed in a countdown form between two requests intervals.

As a preferred embodiment of the present invention, the loading state module is hidden under normal state, and displays and covers button module during the time interval when the request is initiated and waits for the results returned from the backend; at this moment, the button module is disabled and a prompt of loading state is displayed.

Compared with the prior arts, the implementation method based on Http loop request claimed by the present invention has the following beneficial effects: through step 1: setting the initial loading state of the button module as false, the countdown progress bar display of the countdown module as false and the remaining time of the countdown as zero; Step 2: clicking the button module to initiate the Http loop request; Step 3: setting the loading state of the button module as true, wherein the loading state module displays loading state and waits for the result returned from the backend; Step 4: after the result returned from the backend are received, setting the loading state as false, the countdown progress bar display as true, the filling progress as 100%, and the remaining time of the countdown as the initial interval value; Step 5: as the remaining time of the countdown decreases, the filling progress of the countdown progress bar module decreases; when the remaining time decreases to zero, setting the display of the countdown progress bar module as false, and re-initiating the Http request to go to Step 3. The countdown of the request initiation interval is intuitively displayed, which is convenient for prompting the user of the current web state. The button combines the functions of request initiation and request refresh and optimizes the user's operation experience.

The device of the implementation method based on Http loop request of the present invention using a button module, a progress bar module and a loading state module, wherein, the button module is a basic resident module and its internal icon can be customized; the progress bar module is a ring structure wrapping the button module and hidden under normal state, and displayed in a countdown form between two request intervals; the loading state module is located in the center of the button module, hidden under normal state, and displays and covers button module during the time interval when the request is initiated and waits for the results returned from the backend; at this moment, the button module is disabled and a prompt of loading state is displayed. The present invention has the following beneficial effects: the progress bar module, the loading state module and the button module are unified, which saves the web layout space, intuitively displays the countdown of the loop sending request and the loading state waiting for the request result; and the request sending may be customized independently, which is convenient for prompting the user of the current web state, and optimizes the user operation experience.

### BRIEF DESCRIPTION OF THE DRAWINGS

The drawings described here are used to provide a further understanding of the embodiments of the present invention, which forms a part of the application rather than a limitation to the embodiments of the present invention. In the attached picture:

FIG. 1 is a flow chart for applying an implementation method based on Http loop request described in embodiment 1 of the present invention

FIG. 2 is a structural diagram of a device based on Http loop request according to embodiment 2 of the present invention.

### DETAILED DESCRIPTION OF THE PREFERRED EMBODIMENTS

The invention is further described in combination with embodiments, but the following embodiments should not be construed as limitation to the scope of the above subjects of the invention. Technologies realized based on the invention shall fall within the scope of the invention.

### Embodiment 1

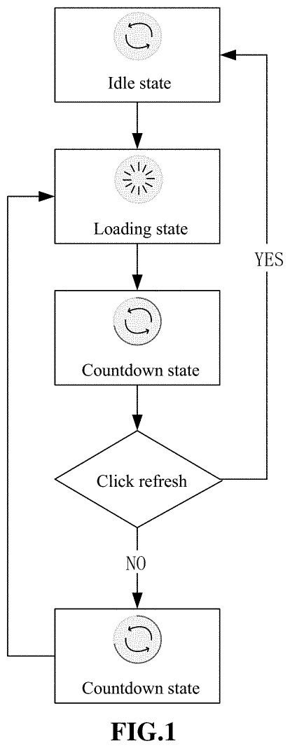

As shown in FIG. 1, an implementation method and device based on Http loop request, comprising the following steps:

Step 1: setting an initial loading state of the button module as false, a countdown progress bar display of the countdown module as false and a remaining time of the countdown as zero;

Step 2: clicking the button module to initiate the Http loop request;

Step 3: setting a loading state of the button module as true, wherein the loading state module displays in loading state and waits for a result returned from the backend;

Step 4: after the result returned from the backend is received, setting the loading state as false, the countdown progress bar display as true, the filling progress as 100%, and resetting the remaining time of the countdown as a initial interval value;

Step 5: as the remaining time of the countdown decreases, the filling progress of the countdown progress bar module decreases, when the remaining time decreases to zero, setting the display of the countdown progress bar module as false, and re-initiating the Http request to go to Step 3.

With the above technical solution, the countdown of the request initiation interval is intuitively displayed, which is convenient for prompting the user of the current web state. The button combines the functions of request initiation and request refresh and optimizes the user's operation experience.

### Embodiment 2

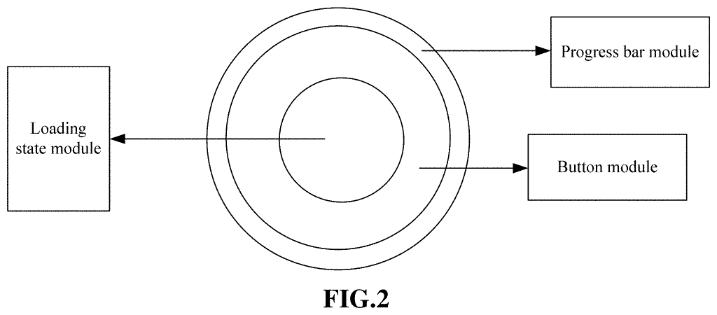

As shown in FIG. 2, a device of the implementation method based on Http loop request, comprising:

a button module which is a basic resident module and used to click the button module to initiate the Http loop request;

a progress bar module which is a ring structure wrapping the button module and used to display the countdown time;

a loading state module which is located in the center of the button module and used to display the loading state of the button module.

The internal icons of the circular button module can be customized.

The progress bar module is hidden under normal state and displayed in a countdown form between two requests intervals.

The loading state module is hidden under normal state and displays and covers button module during the time interval when the request is initiated and waits for the results returned from the backend. At this moment, the button module is disabled and a prompt of loading state is displayed.

With the above technical solution, the progress bar module, the loading state module and the button module are unified to save web layout space and intuitively display the countdown of the request initiation interval, so as to prompt the user of the current web state and optimize the user operation experience.

It should be understood that the embodiments described above are some embodiments rather than limitations of the invention. Any amendment, equivalent replacement and improvement made within the range of the spirit and rule of the present invention shall be included in the protection scope of the present invention.

What is claimed is:

1. An implementation method based on Http loop request, wherein the implementation method comprises the following steps:
Step 1: setting an initial loading state of the button module as false, a countdown progress bar display of the countdown module as false and a remaining time of the countdown as zero;
Step 2: clicking the button module to initiate the Http loop request;
Step 3: setting a loading state of the button module as true, wherein the loading state module displays in loading state and waits for a result returned from the backend;
Step 4: after the result returned from the backend is received, setting the loading state as false, the countdown progress bar display as true, the filling progress as 100%, and resetting the remaining time of the countdown as an initial interval value;
Step 5: as the remaining time of the countdown decreases, the filling progress of the countdown progress bar module decreases, when the remaining time decreases to zero, setting the display of the countdown progress bar module as false, and re-initiating the Http request to go to Step 3.

2. The implementation method based on Http loop request according to claim 1, wherein, the loading state of the button module stated in Step 3 is set as true, and the button module is disabled when the loading state module displays a loading state.

3. The implementation method based on Http loop request according to claim 1, wherein, after the result returned from the backend is received as stated in Step 4, the button module at this moment displays the available state, and the initial time interval value can be customized.

4. A device of the implementation method based on Http loop request according to claim 1, comprising:
a button module which is a basic resident module and used to click the button module to initiate the Http loop request;
a progress bar module which is a ring structure wrapping the button module and used to display the countdown time;
a loading state module which is located in the center of the button module and used to display the loading state of the button module.

5. The device of the implementation method based on Http loop request according to claim 4, wherein the button module is circular, and the inner icons can be customized.

6. The device of the implementation method based on Http loop request according to claim 4, wherein the progress bar module is hidden under normal state, and displayed in a countdown form between two request intervals.

7. The device of the implementation method based on Http loop request according to claim 4, wherein the loading state module is hidden under normal state, and displays and covers button module during the time interval when the request is initiated and waits for the result returned from the backend; at this moment, the button module is disabled and a prompt of loading state is displayed.
